(19) United States
(12) Patent Application Publication
(10) Pub. No.: US 2023/0177329 A1
(43) Pub. Date: Jun. 8, 2023

(54) INFORMATION PROCESSING APPARATUS, INFORMATION PROCESSING METHOD, AND COMPUTER-READABLE RECORDING MEDIUM

(71) Applicant: NEC Corporation, Minato-ku, Tokyo (JP)

(72) Inventor: Yuki Kobayashi, Tokyo (JP)

(73) Assignee: NEC Corporation, Minato-ku, Tokyo (JP)

(21) Appl. No.: 18/008,305

(22) PCT Filed: Jun. 8, 2020
(86) PCT No.: PCT/JP2020/022455

§ 371 Date: Dec. 5, 2022

(51) Int. Cl. G06N 3/08

(52) U.S. Cl. CPC G06N 3/08

(57) ABSTRACT

Provided is an information processing apparatus configured for determining an encryption target from a plurality of weights of a model trained by deep learning, the information processing apparatus includes an encryption target weight selection means for selecting, from among the plurality of weights, a weight of an encryption target, an encryption target weight changing means for changing the selected weight in the trained model, an inference accuracy evaluation means for evaluating an inference accuracy of the trained model with the changed weight, and a control means for repeating selection of the weight by the encryption target weight selection unit until the inference accuracy reaches a target accuracy or less.

### TECHNICAL FIELD

The present invention relates to an information processing apparatus and an information processing method for determining an encryption target, in particular, an encryption target in a circuit in which weights of a model trained by deep learning are embedded, and a computer-readable recording medium that includes a program recorded thereon for realizing the apparatus and method.

### BACKGROUND ART

Recent years have seen incredible advancements in deep learning represented by convolutional neural networks (CNNs), which has led to increasingly higher demands for deep learning performance. In particular, it is important for edge devices such as monitoring cameras to realize high performance required for the latest deep learning algorithms with as little power consumption as possible. When deep learning is executed in edge devices, it is conceivable to use a method using a general-use processor or a method using a GPU (Graphics Processing Unit) for edge devices, but in general, power consumption remains an issue.

On the other hand, examples of methods using a circuit specialized for deep learning include an ASSP (Application Specific Standard Product) for edge AI, or a dedicated ASIC (Application Specific Integrated Circuit). However, long periods of time in the magnitude of months is often required to design an ASSP or an ASIC, which makes it difficult to keep up with the latest deep learning algorithms in the rapidly-changing deep learning field.

A method disclosed in Patent Document 1 is an example of a method for shortening the design period of an ASIC. In the method disclosed in Patent Document 1, a deep learning algorithm is used in a dedicated circuit, and weights of a trained model are embedded in the circuit as a ROM (Read Only Memory). By doing so, although the algorithm or the model cannot be modified, an ASIC with low power consumption and high performance can be designed in a short period of time.

With this method, the design period of an ASIC can be shortened. However, since the weights of trained models are generally a collection of know-how, when the values of the weights are embedded in a circuit, there is a risk that such know-how may be leaked due to information leakage in the manufacturing process of the ASIC, or information leakage due to reverse-engineering of chips after manufacturing, for example. Information leakage in the manufacturing process of an ASIC may be information leakage in a manufacturing fab, for example. Information leakage due to reverse engineering may occur through unpacking semiconductor chips and observing the wiring layers.

As countermeasures for such leakage of circuit information, encryption of a circuit such as that disclosed in Non-patent Document 1, Non-patent Document 2, and the like is known. For example, the logics of a circuit are modified such that, when a circuit is operating, a decryption key is received from the outside, and a correct value is output only when a correct decryption key is given.

### LIST OF RELATED ART DOCUMENTS

### Patent Document

Patent document 1: Japanese Patent Laid-Open Publication No. 2019-042927

### Non-Patent Document

Non-Patent Document 1: M. Yasin, A. Sengupta, B. C. Schafer, Y. Makris, O. Sinanoglu, and J. Rajendran, “What to lock? functional and parametric locking,” Great Lake Symposium on VLSI, pp. 351-356, May 2017.
Non-Patent Document 2: M. Yasin, A. Sengupta, M. T. Nabeel, M. Ashraf, J. J. Rajendran, and O. Sinanoglu, “Provably-secure logic locking: From theory to practice,” Proceedings of the 2017 ACM SIGSAC Conference on Computer and Communications Security, CCS '17, New York, N.Y., USA, pp. 1601-1618, ACM, 2017.

### SUMMARY OF INVENTION

### Problems to be Solved by the Invention

In the method disclosed in Non-Patent Document 1 or Non-Patent Document 2, in the case where all logics are encrypted, the circuit area is increased, which increases power consumption or manufacturing cost. On the other hand, in the case where only some of the logics are encrypted in order to suppress an increase in the circuit area, when an incorrect decryption key is received, only some of the output values are incorrect while most of the output values are correct. In this case, for example, in image processing in which a human eye cannot find differences, even if some of the values are changed, it may make no difference.

Especially, in deep learning, when some of the logics are encrypted and some of the values of the weights are incorrect due to an incorrect decryption key, accuracy may not significantly decrease. The reason being that deep learning is originally designed to tolerate learning errors of weights and the like.

Accordingly, when encrypting a circuit, the weights that significantly influence accuracy degradation of output need to be encrypted as a countermeasure against leakage of circuit information.

An example object of the invention is to provide an information processing apparatus, an information processing method, and a computer-readable recording medium, with which a secure encrypted circuit can be realized while suppressing an increase in a circuit area.

### Means for Solving the Problems

In order to achieve the aforementioned object, an information processing apparatus, according to an example aspect of the present invention, for determining an encryption target from a plurality of weights of a model trained by deep learning, the information processing apparatus comprising: an encryption target weight selection unit that selects, from among the plurality of weights, a weight of an encryption target; an encryption target weight changing unit that changes the selected weight in the trained model; an inference accuracy evaluation unit that evaluates an inference accuracy of the trained model with the changed weight; and a control unit that repeats selection of the weight by the encryption target weight selection unit until the inference accuracy reaches a target accuracy or less.

In order to achieve the aforementioned object, an information processing method according to an example aspect of the present invention, for determining an encryption target from a plurality of weights of a model trained by deep learning, the method comprising: selecting, from among the plurality of weights, a weight of an encryption target; changing the selected weight in the trained model; evaluating an inference accuracy of the trained model with the changed weight; and repeating selection of the weight of the encryption target until the inference accuracy reaches a target accuracy or less.

In order to achieve the aforementioned object, a computer-readable recording medium according to an example aspect of the present invention, that includes a program recorded thereon, the program causing a computer to determine an encryption target from a plurality of weights of a model trained by deep learning, and including instructions that cause the computer to carry out: selecting, from among the plurality of weights, a weight of an encryption target; changing the selected weight in the trained model; evaluating an inference accuracy of the trained model with the changed weight; and repeating selection of the weight of an encryption target until the inference accuracy reaches a target accuracy or less.

### Advantageous Effects of the Invention

According to the present invention, a secure encrypted circuit can be realized while suppressing an increase in a circuit area.

### BRIEF DESCRIPTION OF THE DRAWINGS

FIG. 1 is a configuration diagram showing a schematic configuration of an information processing apparatus.

FIG. 2 is a block diagram for illustrating a specific configuration of the information processing apparatus.

FIG. 3 is a flowchart showing an operation of the information processing apparatus.

FIG. 4 is a block diagram showing one example of a computer that realizes the information processing apparatus in the example embodiment.

### EXAMPLE EMBODIMENT

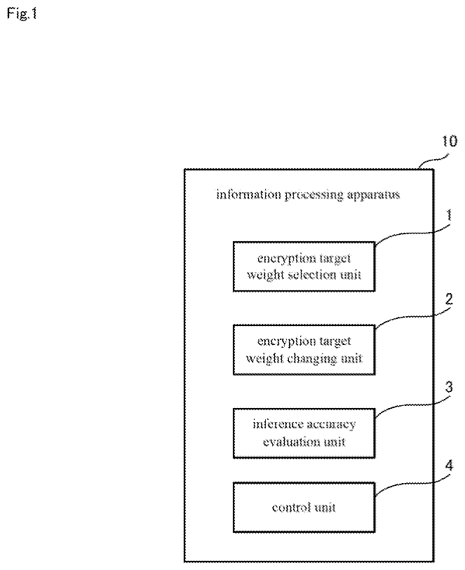

Hereinafter, an information processing apparatus according to an example embodiment of the invention will be described with reference to FIGS. 1 to 4.

[Apparatus Configuration]

First, a schematic configuration of the information processing apparatus according to the example embodiment of the invention will be described with reference to FIG. 1. FIG. 1 is a configuration diagram showing a schematic configuration of an information processing apparatus 10.

The information processing apparatus 10 is an apparatus for determining an encryption target from a plurality of weights of a model trained through deep learning. The information processing apparatus 10 is provided with an encryption target weight selection unit 1, an encryption target weight changing unit 2, an inference accuracy evaluation unit 3, and a control unit 4.

The encryption target weight selection unit 1 selects the weight of an encryption target from among the plurality of weights of the model trained through deep leaning.

The encryption target weight changing unit 2 changes the weight selected by the encryption target weight selection unit 1 in the trained model.

The inference accuracy evaluation unit 3 evaluates the inference accuracy using the trained model of which the weight has been changed by the encryption target weight changing unit 2.

The control unit 4 repeats selection of a weight using the encryption target weight selection unit 1 until the inference accuracy evaluated by the inference accuracy evaluation unit 3 reaches a target accuracy or less.

According to this configuration, the information processing apparatus 10 can realize a secure encrypted circuit while suppressing an increase in the circuit area. Specifically, the information processing apparatus 10 detects the weights that significantly influence degradation of accuracy of output. When circuitizing a trained model, only the weights detected by the information processing apparatus 10 are encrypted. In this manner, in the realized circuit, accuracy is significantly degraded when an incorrect decryption key is given. Also, since it is not necessary to encrypt all of the logics (weights), it is possible to prevent an increase in the circuit area, the power consumption, and the manufacturing cost.

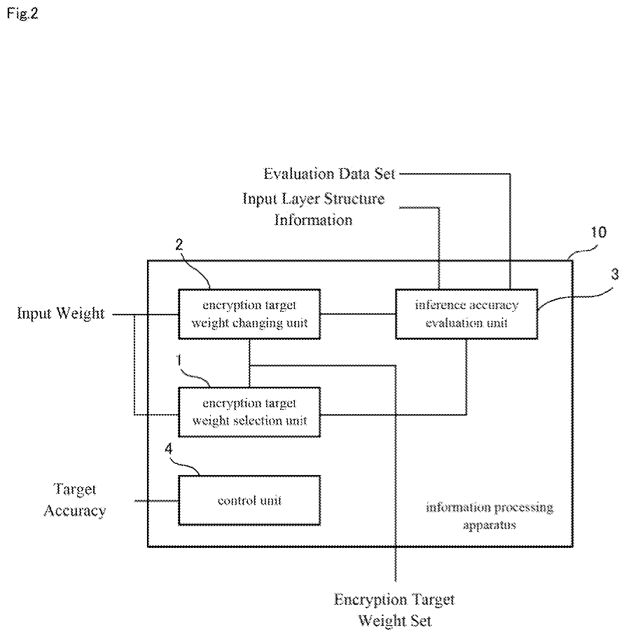

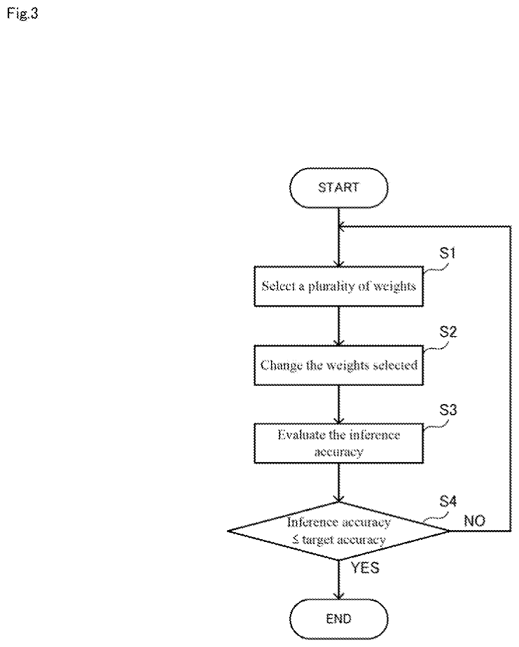

Next, using FIGS. 2 and 3, the configuration and function of the encryption target weight selection unit 1 of the example embodiment will be described in detail. FIG. 2 is a block diagram for illustrating a specific configuration of the information processing apparatus 10.

A model trained through deep learning is input to the information processing apparatus 10. In the following description, the weights of the trained model that are input are referred to as “input weights”. The encryption target weight selection unit 1 selects a plurality of weights that are to be encryption targets from among the input weights, and saves the selected weights as a selected weight set.

Here, one or a plurality of weights can be selected at a single time. Also, there are conceivably various ways of selecting the selection targets. For example, the weights can be selected in order or at random. Also, the weights can be searched for exhaustively, in a breadth-first order, or through simulated annealing. Also, each time the weights are selected, the selected weights can be added to the selected weight set, the selected weights can be deleted from the selected weight set, or the addition and deletion of the selected weights can be performed at the same time.

The encryption target weight changing unit 2 changes the values of the weights in the selected weight set selected by the encryption target weight selection unit 1. Here, there are conceivably various methods for changing the values. For example, the values may be changed to zero or a specific value, bit-inversed, multiplied by a specific coefficient, or replaced with a random number.

The inference accuracy evaluation unit 3 evaluates the inference accuracy using the trained model of which the weight has been changed by the encryption target weight changing unit 2 and an evaluation data set that is received by the information processing apparatus 10. More specifically, the inference accuracy evaluation unit 3 performs inference processing regarding deep learning to evaluate the inference accuracy, based on layer structure information in the trained model, the weights (the weights that are not changed) not selected by the encryption target weight selection unit 1 from among the plurality of weights of the trained model, the weight changed by the encryption target weight changing unit 2, and an evaluation data set. The evaluation data set is a data set used for evaluating the trained model.

The control unit 4 compares a target accuracy that is input to the information processing apparatus 10 as an input, with an inference accuracy evaluated by the inference accuracy evaluation unit 3, and if the inference accuracy has degraded to the target value, the control unit 4 outputs the selected weight set selected by the encryption target weight selection unit 1 as an encryption target weight set, and ends the processing. Also, if the inference accuracy has not reached the target accuracy, the control unit 4 selects the encryption target again using the encryption target weight selection unit 1.

### [Apparatus Operation]

Next, operation of the information processing apparatus 10 according to the first example embodiment will be described using FIG. 3. FIG. 3 is a flowchart showing an operation of the information processing apparatus 10. In the following description, FIGS. 1 and 2 will be referred to as appropriate. In the example embodiment, the information processing method is implemented by operating the information processing apparatus 10. Therefore, the following description of the operations of the information processing apparatus 10 will be given in place of a description of the information processing method according to the example embodiment.

First, as the initial operation, the information processing apparatus 10 initializes the selected weight set with an empty set. This operation may be performed by the encryption target weight selection unit 1 or another functional unit. The encryption target weight selection unit 1 selects a plurality of weights that are to be encrypted from among the input weights (S1). At this time, the encryption target weight selection unit 1 saves the selected plurality of weights as a selected weight set. Also, the encryption target weight selection unit 1 adds weights to or deletes weights from the selected weight set.

Next, the encryption target weight changing unit 2 changes the weights selected in S1 in the trained model (S2). The inference accuracy evaluation unit 3 performs the inference processing regarding deep learning using the trained model for which the weights were changed in step S2 and the evaluation data set, and evaluates the inference accuracy (S3).

The control unit 4 compares the inference accuracy evaluated in S3 and the input target accuracy, and determines whether the inference accuracy is less than or equal to the target accuracy (S4). If the inference accuracy is not less than or equal to the target accuracy (S4: NO), the processing of S1 is executed again. If the inference accuracy is less than or equal to the target accuracy (S4: YES), the control unit 4 outputs the selected weight set as the encryption target weight set, and ends the processing.

When realizing an encrypted circuit of a trained model, an increase in the circuit area of the encrypted circuit can be suppressed by encrypting only some of the weights (logics) based on the encryption target weight set that is output from the information processing apparatus 10. Also, because the weights with which the inference accuracy degradation is significant when an incorrect decryption key is given are encrypted, even if the circuit information is read out through reverse engineering or the like and the weights are leaked, the inference accuracy when the weights are used is low, and thus the risk of the know-how being leaked can be suppressed.

Note that, although encryption of a circuit has been described in the example embodiment, the example embodiment is not limited to encryption of a circuit, and can be applied to encryption of weight parameters stored in a memory of a general-purpose processor, a GPU, or an ASSP. In the other words, in addition to the case that is assumed in the example embodiment, in which an encrypted parameter is embedded as a circuit (ROM), the example embodiment can be applied to a case where an encrypted parameter is stored in an external memory or the like and a decryption circuit or a decryption program is provided in a circuit. For example, since only some of the weights need to be decrypted, it is possible to contribute to a reduction in processing time and power consumption, while there is an effect that the inference accuracy is significantly degraded when an incorrect decryption key is given.

[Program]

A program according to the example embodiment need only be a program that causes a computer to execute steps S1 to S4 shown in FIG. 3. The information processing apparatus 10 and the information processing method according to the example embodiment can be realized by this program being installed in the computer and executed. In this case, a processor of the computer performs processing, while functioning as the encryption target weight selection unit 1, the encryption target weight changing unit 2, the inference accuracy evaluation unit 3, and the control unit 4.

Further, examples of a computer include a smartphone and a tablet terminal apparatus, in addition to a general-purpose PC.

Also, the program of the example embodiment may also be executed by a computer system constituted by a plurality of computers. In this case, each of the computers may function as any one of the encryption target weight selection unit 1, the encryption target weight changing unit 2, the inference accuracy evaluation unit 3, and the control unit 4.

[Physical Configuration]

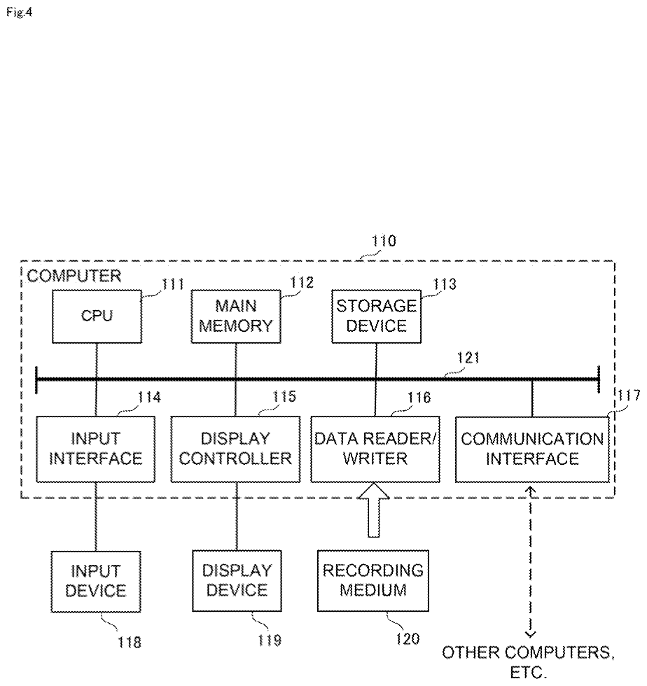

Hereinafter, a computer that realizes the information processing apparatus 10 by executing the program in the example embodiment will be described with reference to FIG. 4. FIG. 4 is a block diagram showing one example of a computer that realizes the information processing apparatus 10 in the example embodiment.

As shown in FIG. 4, a computer 110 includes a CPU 111, a main memory 112, a storage device 113, an input interface 114, a display controller 115, a data reader/writer 116, and a communication interface 117. These components are connected in such a manner that they can perform data communication with one another via a bus 125.

Note that the computer 110 may include a GPU (Graphics Processing Unit) or an FPGA (Field-Programmable Gate Array) in addition to the CPU 111 or in place of the CPU 111.

The CPU 111 carries out various types of computation by deploying the program (codes) in the present example embodiment stored in the storage device 113 to the main memory 112, and executing the deployed program in a predetermined order. The main memory 112 is typically a volatile storage device, such as a DRAM (Dynamic Random Access Memory).

Also, the program in the present example embodiment is provided in a state where it is stored in a computer readable recording medium 120. Note that the program in the present example embodiment may also be distributed over the Internet connected via the communication interface 117.

Furthermore, specific examples of the storage device 113 include a hard disk drive, and also a semiconductor storage device, such as a flash memory. The input interface 114 mediates data transmission between the CPU 111 and an input apparatus 118, such as a keyboard and a mouse. The display controller 115 is connected to a display apparatus 119, and controls displays on the display apparatus 119.

The data reader/writer 116 mediates data transmission between the CPU 111 and the recording medium 120, and executes readout of the program from the recording medium 120, as well as writing of the result of processing in the computer 110 to the recording medium 120. The communication interface 117 mediates data transmission between the CPU 111 and other computers.

Also, specific examples of the recording medium 120 include: a general-purpose semiconductor storage device, such as CF (Compact Flash) and SD (Secure Digital); a magnetic recording medium, such as Flexible Disk; and an optical recording medium, such as CD-ROM (Compact Disk Read Only Memory).

Note that the information processing apparatus 10 in the present example embodiment can also be realized using items of hardware corresponding to respective components, rather than using the computer with the program installed therein. Furthermore, a part of the information processing apparatus 10 may be realized by the program, and the remaining part of the information processing apparatus 10 may be realized by hardware.

A part or all of the aforementioned example embodiment can be described as, but is not limited to, the following (Supplementary Note 1) to (Supplementary Note 6).

(Supplementary Note 1)

An information processing apparatus for determining an encryption target from a plurality of weights of a model trained by deep learning, the information processing apparatus comprising:

an encryption target weight selection unit that selects, from among the plurality of weights, a weight of an encryption target;

an encryption target weight changing unit that changes the selected weight in the trained model;

an inference accuracy evaluation unit that evaluates an inference accuracy of the trained model with the changed weight; and

a control unit that repeats selection of the weight by the encryption target weight selection unit until the inference accuracy reaches a target accuracy or less.

(Supplementary Note 2)

The information processing apparatus according to Supplementary Note 1, wherein the inference accuracy evaluation unit evaluates the inference accuracy using the trained model and an input evaluation data set.

(Supplementary Note 3)

An information processing method for determining an encryption target from a plurality of weights of a model trained by deep learning, the method comprising:

a step of selecting, from among the plurality of weights, a weight of an encryption target;

a step of changing the selected weight in the trained model;

a step of evaluating an inference accuracy of the trained model with the changed weight; and

a step of repeating selection of the weight of an encryption target until the inference accuracy reaches a target accuracy or less.

(Supplementary Note 4)

The information processing method according to Supplementary Note 3,

wherein, in the step of evaluating the inference accuracy, the inference accuracy is evaluated using the trained model and an input evaluation data set.

(Supplementary Note 5)

A computer-readable recording medium that includes a program recorded thereon, the program causing a computer to determine an encryption target from a plurality of weights of a model trained by deep learning, and including instructions that cause the computer to carry out

a step of selecting, from among the plurality of weights, a weight of an encryption target;

a step of changing the selected weight in the trained model;

a step of evaluating an inference accuracy of the trained model with the changed weight; and

a step of repeating selection of the weight of an encryption target until the inference accuracy reaches a target accuracy or less.

(Supplementary Note 6)

The computer-readable recording medium according to Supplementary Note 5,

wherein, in the step of evaluating the inference accuracy, the inference accuracy is evaluated using the trained model and an input evaluation data set.

As the describe, the present invention has been described with reference to the embodiments, the present invention is not limited to the above embodiments. Various changes that can be understood by those skilled in the art can be made to the configuration and details of the present invention within the scope of the present invention.

### LIST OF REFERENCE SIGNS

1 encryption target weight selection unit
2 encryption target weight changing unit
3 inference accuracy evaluation unit
4 control unit
10 information processing apparatus
110: Computer
111: CPU
112: Main Memory
113: Storage Device
114: Input Interface
115: Display Controller
116: Data Reader/Writer
117: Communication Interface
118: Input Device
119: Display Apparatus
120: Recording Medium
121: Bus

What is claimed is:

1. An information processing apparatus for determining an encryption target from a plurality of weights of a model trained by deep learning, the information processing apparatus comprising:
an encryption target weight selection unit that selects from among the plurality of weights, a weight of an encryption target;
an encryption target weight changing unit that changes the selected weight in the trained model;
an inference accuracy evaluation unit that evaluates an inference accuracy of the trained model with the changed weight; and
a control unit that repeats selection of the weight by the encryption target weight selection unit until the inference accuracy reaches a target accuracy or less.

2. The information processing apparatus according to claim 1,
wherein the inference accuracy evaluation unit evaluates the inference accuracy using the trained model and an input evaluation data set.

3. An information processing method for determining an encryption target from a plurality of weights of a model trained by deep learning, the method comprising:
selecting, from among the plurality of weights, a weight of an encryption target;
changing the selected weight in the trained model;
evaluating an inference accuracy of the trained model with the changed weight; and
repeating selection of the weight of an encryption target until the inference accuracy reaches a target accuracy or less.

4. The information processing method according to claim 3,
wherein, in the evaluating the inference accuracy, the inference accuracy is evaluated using the trained model and an input evaluation data set.

5. A non-transitory computer-readable recording medium that includes a program recorded thereon, the program causing a computer to determine an encryption target from a plurality of weights of a model trained by deep learning, and including instructions that cause the computer to carry out:
selecting, from among the plurality of weights, a weight of an encryption target;
changing the selected weight in the trained model;
evaluating an inference accuracy of the trained model with the changed weight; and
repeating selection of the weight of an encryption target until the inference accuracy reaches a target accuracy or less.

6. The non-transitory computer-readable recording medium according to claim 5,
wherein, in the evaluating the inference accuracy, the inference accuracy is evaluated using the trained model and an input evaluation data set.
